(19) United States
(12) Patent Application Publication
(10) Pub. No.: US 2013/0232810 A1
(43) Pub. Date: Sep. 12, 2013

(54) DOOR HANDLE FOR A WASHING MACHINE OR DRYER APPLIANCE

(71) Applicants: David John Coxon, Louisville, KY (US); Nicolas Castrillon, Louisville, KY (US); Paul Stephen Haney, Pewee Valley, KY (US)

(72) Inventors: David John Coxon, Louisville, KY (US); Nicolas Castrillon, Louisville, KY (US); Paul Stephen Haney, Pewee Valley, KY (US)

(73) Assignee: GENERAL ELECTRIC COMPANY, Schenectady, NY (US)

(21) Appl. No.: 13/415,091

(22) Filed: Mar. 8, 2012

(51) Int. Cl. F26B 11/02; D06F 39/14; D06F 58/20; D06F 37/10

(52) U.S. Cl. 34/108; 68/139; 312/228

(57) ABSTRACT

An appliance is provided with a door mounted to a cabinet of the appliance. The door has a handle that is defined by a recess in a sidewall of the door. The handle can be positioned on the door such that the door is suitable for use on either a washing machine appliance or a dryer appliance.

### FIELD OF THE INVENTION

The present subject matter is directed to door handles, e.g., for washing machine or dryer appliances.

### BACKGROUND OF THE INVENTION

Washing machine appliances and dryer appliances generally include a cabinet that has a drum rotatably mounted therein. An opening defined by the cabinet permits access to a chamber defined by the drum. Articles to be washed or dried respectively are placed within the chamber through the opening.

To permit selective access to the chamber, a door is rotatably mounted to the cabinet with a hinge such that the door may rotate between an open configuration and a closed configuration. For example, a user can pull on a handle of the door in order to open the door. To close the door, the user can push on the handle or on the door's outer surface. To assist in opening and closing the door, the handle can be positioned on the door on an opposite side from the hinge. The further the distance between the handle and the hinge, the less the amount of force required for a user to open and/or close the door.

Horizontal axis washing machine and dryer appliances are preferred by certain consumers. In horizontal axis washing machine and dryer appliances, the drum rotates about a substantially horizontal axis within the cabinet. In such appliances, the door permitting access to the chamber defined by the drum is generally mounted to a front panel of the cabinet.

In addition, washing machine appliances and dryer appliances can be sold in matching pairs. In a matching pair, the washing machine appliance and dryer appliance can have a substantially similar appearance. Thus, for example, in a matching horizontal axis washing machine and dryer appliance pair, the doors of the appliances can be mounted to a respective front panel of the appliances' cabinets and can have a substantially similar appearance. Generally, in a matching pair, the appliances' doors are mounted such that the door of the washing machine appliance rotates open in one direction and the door of the dryer appliance rotates open in an opposite direction. Thus, in such pairs, the doors' handles are generally mounted on opposite sides relative to one another. However, the doors can be mounted in other configurations and may be provided with an option for the consumer to change the hinge side as desired.

Because it may be desirable for doors of the washing machine appliance and the dryer appliance to appear similar in a matching appliance pair and because doors can be mounted differently within the matching pair (i.e., the doors on the appliances may rotate in opposite directions), a door that may be mounted to a washing machine appliance or a dryer appliance in a matching pair and have a substantially similar appearance on both of the appliances would be useful. However, because the doors' handles are generally mounted on opposite sides of the appliance, a door with a handle that may be mounted to a washing machine appliance or a dryer appliance in a matching pair and have a substantially similar appearance on both of the appliances would also be useful.

In addition, certain handles for washing machine and dryer appliance doors can be visually distracting and/or unappealing to potential consumers. For example, a large, bulky handle attached to the outer surface of the door can be unappealing. Thus, a handle for a washing machine or dryer appliance door that is visually appealing and/or unobtrusive would be advantageous. However, a handle should not be unobtrusive to the extent that the handle is difficult to find and/or operate. Thus, a handle for a washing machine or dryer appliance door that is visually appealing and/or unobtrusive while also providing a highly visual indicator of the position and intent of the handle would be beneficial.

Also, handles for washing machine and dryer appliance doors can be used frequently. Thus, such handles can require a durable fastening and/or mounting mechanism to secure the handles to doors. Accordingly, a handle for washing machine and dryer appliance doors with features for durably mounting the handle to the doors would be useful.

### BRIEF DESCRIPTION OF THE INVENTION

Aspects and advantages of the invention will be set forth in part in the following description, or may be obvious from the description, or may be learned through practice of the invention.

In a first embodiment, an appliance is provided. The appliance includes a cabinet defining an opening. A drum is rotatably mounted within the cabinet such that the drum rotates about a substantially horizontal axis. The drum defines a chamber configured for receipt of articles. The chamber of the drum is accessible through the opening of the cabinet. A hinge is mounted to the cabinet adjacent the opening of the cabinet. A door is rotatably mounted to the cabinet with the hinge. The door is configured for permitting selective access to the chamber of the drum. The door includes an inner surface that is positioned adjacent the cabinet. The inner surface has an outer perimeter. An outer surface is spaced apart from the inner surface. The outer surface has an outer edge. A sidewall spans between the outer perimeter and the outer edge. A handle is defined by a recess in the sidewall.

In a second embodiment, an appliance is provided. The appliance includes a cabinet that defines an opening. A drum is rotatably mounted within the cabinet such that the drum rotates about a substantially horizontal axis. The drum defines a chamber configured for receipt of articles. The chamber of the drum is accessible through the opening of the cabinet. A hinge is mounted to the cabinet proximate the opening of the cabinet. A door is rotatably mounted to the cabinet with the hinge. The door is configured for permitting selective access to the chamber of the drum. The door includes a frame positioned proximate the cabinet. The frame has an outer edge. The door also includes a cover. The cover is complementary in shape to the frame. The cover is aligned with and positioned proximate to the frame. The cover has a frontal surface. The frontal surface of the cover has an outer perimeter. A sidewall extends between the outer perimeter of the frontal surface of the cover and the outer edge of the frame. A handle is defined by the sidewall.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of a washing machine appliance according to an exemplary embodiment of the present subject matter and, in particular, illustrates an exemplary door of the washing machine appliance.

FIG. 2 provides a perspective view of a dryer appliance according to an exemplary embodiment of the present subject matter and, in particular, illustrates an exemplary door of the dryer appliance.

FIG. 3 provides a perspective view of the exemplary dryer appliance of FIG. 2 with a portion of a cabinet of the dryer appliance removed to reveal an interior of the dryer appliance.

FIG. 4 illustrates a perspective view of the door of the washing machine appliance of FIG. 1 and particularly illustrates an exemplary handle of the door.

FIGS. 5-8 illustrate perspective views of the handle of the door of FIG. 3 in various states of attaching the handle to the door.

### DETAILED DESCRIPTION OF THE INVENTION

An appliance is provided with a door mounted to a cabinet of the appliance. The door has a handle that is defined by a recess in a sidewall of the door. The handle can be positioned on the door such that the door is suitable for use on either a washing machine appliance or a dryer appliance. Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

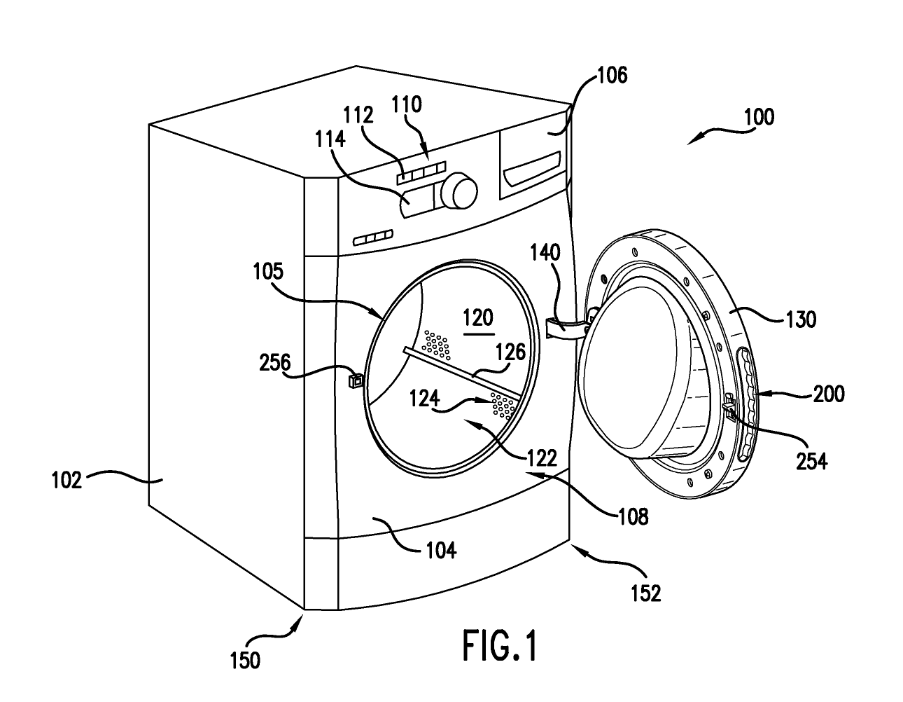

FIG. 1 illustrates an exemplary horizontal axis washing machine appliance 100. However, while described in the context of a specific embodiment of horizontal axis washing machine appliance 100, using the teachings disclosed herein it will be understood that horizontal axis washing machine appliance 100 is provided by way of example only. Other washing machine appliances having different configurations, different appearances, and/or different features may also be utilized with the present subject matter as well.

Washing machine appliance 100 has a cabinet 102 with a drum 120 rotatably mounted therein. Cabinet 102 extends between a first side 150 and a second side 152. A motor (not shown) is in mechanical communication with drum 120 in order to selectively rotate drum 120 (e.g., during an agitation or a rinse cycle of washing machine appliance 100). Drum 120 defines a wash chamber 122 that is configured for receipt of articles for washing. Ribs 126 extend from drum 120 into wash chamber 122. Ribs 126 assist agitation of articles disposed within wash chamber 122 during operation of washing machine appliance 100. For example, ribs 126 may lift articles disposed in drum 120 during rotation of drum 120. Drum 120 also defines a plurality of holes 124. Holes 124 are configured to permit a flow of wash fluid between an interior of drum 120 and an exterior of drum 120.

Cabinet 102 of washing machine appliance 100 has a front panel 104. A detergent drawer 106 is slidably mounted within front panel 104. Detergent drawer receives detergent and directs said detergent to wash chamber 122 during operation of appliance 100. Front panel 104 defines an opening 105 that permits user access to wash chamber 122 of drum 120. A door 130 is mounted to front panel 104 with a hinge 140. A latch with a male latch portion 254 and a female latch portion 256 is configured for selectively securing door 130 in a closed configuration (i.e., a configuration in which door 130 is positioned adjacent front panel 104).

Door 130 provides selective access to wash chamber 122. A user may selectively adjust door 130 between a closed positioned (not shown) and an open position (shown in FIG. 1) in which the user may access wash chamber 122 of drum 120. A user may adjust door 130 between the open and closed configurations by rotating door 130 about hinge 140. For example, to open door 130 from closed configuration, the user may pull on handle 200 in order to rotate door 130 open. Handle 200 is discussed in greater detail below. Hinge 140 is mounted to cabinet 102 on second side 152 of cabinet 102 opposite of handle 200 that is positioned on first side 150 of cabinet 102.

Front panel 104 also includes a control panel 110 with a plurality of input selectors 112. Control panel 110 and input selectors 112 collectively form a user interface input for operator selection of machine cycles and features. A display 114 of control panel 110 indicates selected features, a countdown timer, and/or other items of interest to appliance users.

Operation of washing machine appliance 100 is controlled by a controller or processing device (not shown), that is operatively coupled to control panel 110 for user manipulation to select washing machine cycles and features. In response to user manipulation of control panel 110, the controller operates the various components of washing machine appliance 100 to execute selected machine cycles and features.

In an illustrative embodiment, laundry items are loaded into wash chamber 122, and washing operation is initiated through operator manipulation of input selectors 112. Drum 120 is filled with water and detergent to form a wash fluid. One or more valves (not shown) can be controlled by washing machine appliance 100 to provide for filling drum 120 to the appropriate level for the amount of articles being washed. Once drum 120 is properly filled with fluid, the contents of wash chamber 122 are agitated with ribs 126 for cleansing of laundry items in drum 120.

After the agitation phase of the wash cycle is completed, drum 120 is drained. Laundry articles can then be rinsed by again adding fluid to drum 120, depending on the particulars of the cleaning cycle selected by a user, ribs 126 may again provide agitation within wash chamber 122. One or more spin cycles may also be used. In particular, a spin cycle may be applied after the wash cycle and/or after the rinse cycle in order to wring wash fluid from the articles being washed. During a spin cycle, drum 120 is rotated at relatively high speeds.

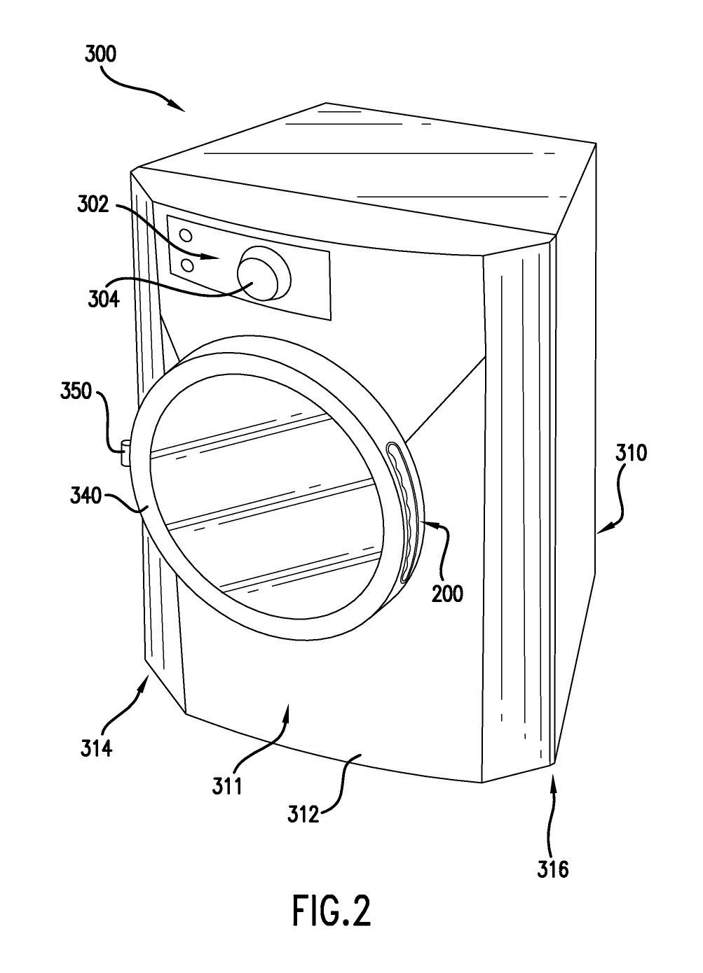

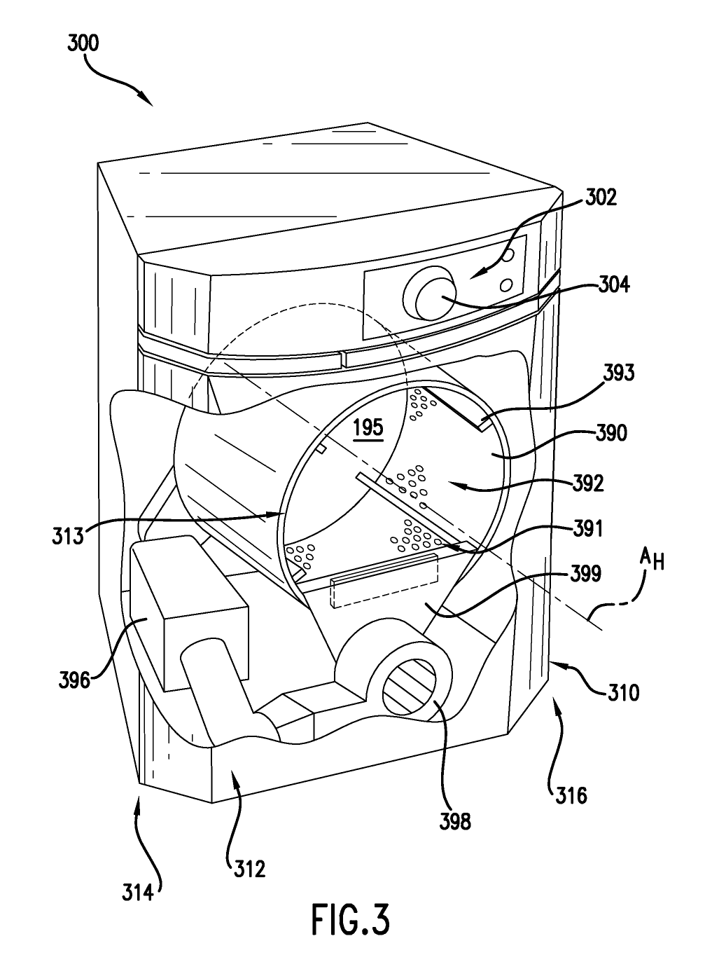

FIGS. 2 and 3 provide perspective views of a dryer appliance 300 according to an exemplary embodiment of the present subject matter. However, while described in the context of a specific embodiment of dryer appliance 300, using the teachings disclosed herein it will be understood that dryer appliance 300 is provided by way of example only. Other dryers having different appearances and different features may also be utilized with the present invention as well.

The dryer appliance 300 includes a main housing or cabinet 310 with a drum 390 rotatably mounted therein. Cabinet 302 extends between a first side 314 and a second side 316. Drum 390 defines a drying chamber 392 configured for receipt of articles for drying. A motor (not shown) rotates drum 390 about an axis A_{H}. Drum 390 is generally cylindrical in shape and defines a plurality of holes 391. An opening 313 is defined by drum 390 in order to allow a user to access to drying chamber 392, e.g., for loading and unloading of articles (e.g., clothing and/or other fabrics) into drying chamber 392.

Cabinet 310 has a door 340 rotatably mounted to front panel 312 with a hinge 350 adjacent opening 313. Hinge 350 is mounted to cabinet 310 on first side 314 of cabinet 310 opposite of handle 200 that is positioned on second side 316 of cabinet 310. Door 340 provides selective access to drying chamber 392. A user may selectively adjust door 340 between a closed positioned (shown in FIG. 2) and an open position (not shown) in which the user may access chamber 392 of drum 390. A user may adjust door 340 between the open and closed configurations by rotating door 340 about hinge 350. For example, to open door 340 from closed configuration shown in FIG. 2, the user may pull on handle 200 in order to rotate door 340 open. Handle 200 is discussed in greater detail below.

A plurality of tumbling ribs 393 are provided within drum 390 to lift articles disposed therein and then allow them to tumble back to the bottom of drum 390 as drum 390 rotates. Drum 390 also includes a rear wall 395 rotatably supported within cabinet 310 by a suitable fixed bearing. Rear wall 395 can be fixed or can be rotatable. Plurality of holes 391 receive hot air that has been heated by a heating system 396. Air is drawn from drum 390 by a blower fan 398. The air passes through a lint or screen filter 399 which traps lint particles. As the air passes from the blower fan 398, it is passed into the heating system 396. Heated air exits heating system 396 and returns to drum 390. After they have been dried, the articles are removed from drum 390 via opening 313.

A cycle selector knob 304 is mounted on front panel 312 and is in communication with a processing device or controller (not shown) connected with a user interface panel 302. Signals generated in the controller operate the drum drive system and heating system 396 in response to the user manipulation of the selector knobs 304. Alternatively, a touch screen type interface may be provided. As used herein, “processing device” or “controller” may refer to one or more microprocessors or semiconductor devices and is not restricted necessarily to a single element. The processing device can be programmed to operate dryer appliance 300 according to methods well known in the art. The processing device may include, or be associated with, one or memory elements such as e.g., electrically erasable, programmable read only memory (EEPROM).

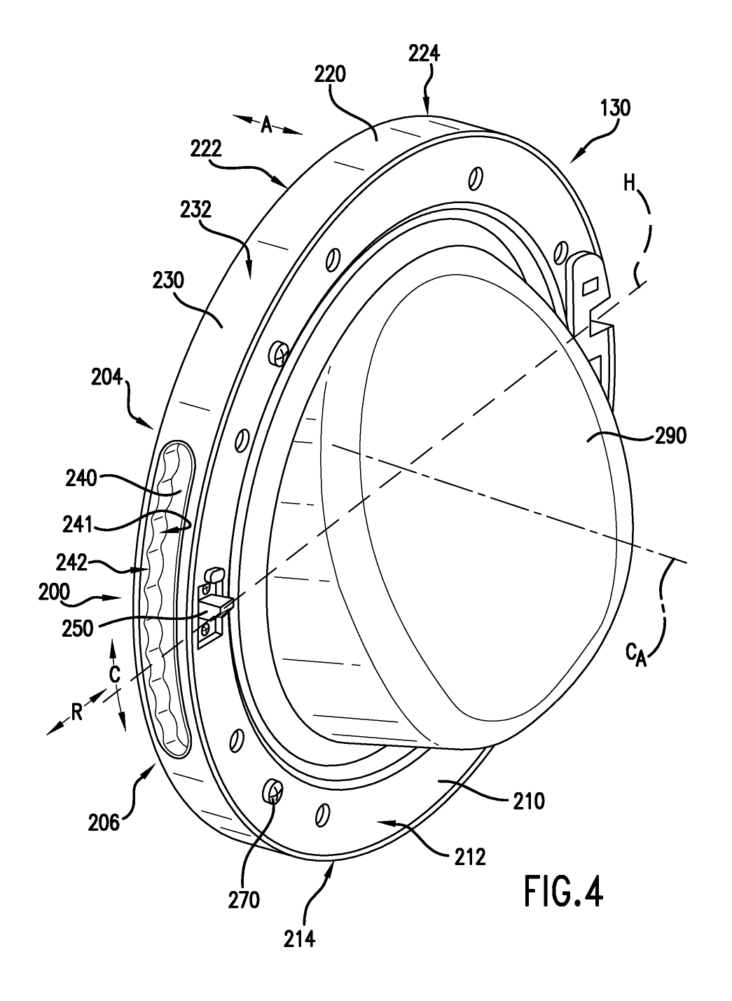

FIG. 4 illustrates door 130 of washing machine appliance 100 shown in FIG. 1. Door 130 defines an axial direction A, a circumferential direction C and a radial direction R. Door 130 includes a frame 210 and a cover 220. Cover 220 is complementary in shape to frame 210. Thus, in FIG. 4, frame 210 is substantially ring shaped, and cover 220 is similarly ring shaped. In alternative embodiments, frame 210 and cover 220 may have any other suitable alternative shape. In addition, door 130 may comprise a single element rather than a separate frame and cover.

Cover 220 is aligned with frame 210 and is positioned proximate to frame 210. Frame 210 and cover 220 receive each other in a complementary manner and are secured together with a plurality of fasteners 270 in order to support a window 290. Window 290 is disposed between frame 210 and cover 220 and permits viewing of the wash chamber 122 (shown in FIG. 1). However, door 130 need not include a window, and, thus, need not permit viewing of wash chamber 122 in alternative embodiments.

Door 130 has an inner surface 212 positioned adjacent cabinet 102 when door 130 is the closed configuration, e.g., adjacent an exterior surface 108 of cabinet 102 when door 130 is the closed configuration. Door 130 also has an outer surface 222 spaced apart from inner surface 212 along the axial direction A. In FIG. 4, frame 210 includes inner surface 212, and cover 220 includes outer surface 222—e.g. a frontal surface. However, in alternative embodiments, inner and outer surfaces 212,222 may be defined in any suitable manner, e.g., as discussed above, door 130 may comprise a single element rather than a separate frame and cover.

Inner surface 212 has an outer perimeter 214. Outer perimeter 214 corresponds to a perimeter of inner surface 212 that is most extremely positioned along the radial direction R to a central axis C_{A} that passes through a centroid of door 130 and is substantially perpendicular to horizontal axis H. In FIG. 4, because door 130 is substantially round and has a substantially circular profile, outer perimeter 214 is also substantially circular. However, door 130 may have any suitable profile and shape (e.g., square, rectangular, or oval), thus, outer perimeter 214 may have any suitable corresponding shape.

Similarly, outer surface 222 has an outer boundary—i.e., outer edge 224. Outer edge 224 corresponds to a perimeter of outer surface 222 that is most extremely positioned along the radial direction R to the central axis C_{A} of door 130. Like above, because door 130 is substantially round and has a substantially circular profile, outer edge 224 is also substantially circular. However, door 130 may have any suitable profile and shape, thus, outer edge 214 may have any suitable corresponding shape.

A sidewall 230 extends or spans between outer perimeter 214 and outer edge 224 along the axial direction A. Thus, sidewall 230 extends between inner surface 212 and outer surface 222 along the axial direction A and corresponds to a surface of door 130 that is most extremely positioned along the radial direction to the central axis C_{A} of door 130. In FIG. 4, because door 130 is round, external surface 232 is positioned about the circumference of door 130. Accordingly, in FIG. 4, sidewall 230 includes the outer circumferential surface 232 of door 130.

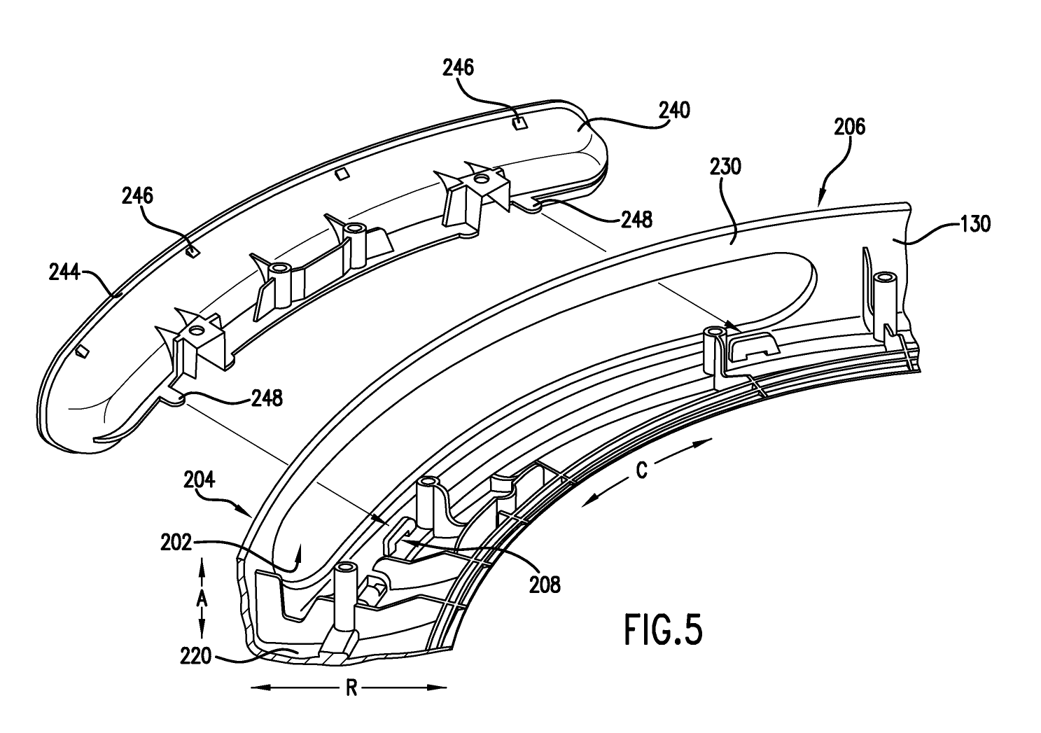

A handle 200 is defined by door 130. Handle 200 is defined by a recess 202 (shown in FIG. 5) in sidewall 230. As will be discussed in greater detail below, handle 200 also includes an insert 240 that is received within recess 202. However, it should be understood that handle 200 may be defined solely by door 130 and need not include insert 240. Handle 200 can assist a user in selectively adjusting door 130 between the open (shown in FIG. 1) and closed (not shown) configurations. For example, when door 130 is in the closed configuration (not shown), the user can insert his or her fingers into handle 200 and pull on handle 200 in order to adjust door 130 to the open configuration (not shown). Thus, insert 240 has an interior surface 241 that is configured for the user to interact with, e.g., when opening door 130. Inner surface 241 has a plurality of texture ribs 242 that can assist the user during interaction with handle 200, e.g., by preventing slippage.

Handle 200 extends along the circumferential direction C between a top 204 and a bottom 206. Top and bottom 204,206 are positioned adjacent and/or proximate sidewall 230. Top and bottom 204,206 are positioned on sidewall 230 such that top and bottom 204,206 are about equidistant from a horizontal axis H along the circumferential direction C. As shown in FIG. 4, horizontal axis H bisects door 130. However, other positions for handle 200 may be used as well.

Because horizontal axis H bisects door 30, handle 200 is positioned on door 130 such that door 130 can be selectively adjusted between a first orientation and a second orientation. In the first orientation, door 130 is configured with handle 200 on first side 150 (FIG. 1) of cabinet 102 (FIG. 1). In the second orientation, door 130 is configured with handle 200 on second side 152 (FIG. 1) of cabinet 102. Door 130 can be adjusted from the first orientation to the second orientation by rotating door 130 about central axis C_{A} by about 180°. Because horizontal axis H bisects door 130, handle 200 will be mirrored between first and second orientations and can be mounted to cabinet 102 with hinge 140 in both first and second orientations.

It is should be understood that door 130 (FIG. 1) of washing machine appliance 100 is substantially similar to door 330 (FIG. 2) of dryer appliance 300. Thus, for example, doors 130, 340 may each have handle 200 with frame 210, cover 220, and insert 240. However, doors 130, 340 may be constructed differently. For example, door 340 of washing machine appliance 100 may have has a plastic frame 210, while door 340 of dryer appliance 300 has a metal frame 210 in order to resist the heat generated during operation of dryer appliance 300. Also, door 130 of washing machine appliance 100 has a male portion 254 (FIG. 1) of latch 250 mounted to door 130, while door 330 of dryer appliance 300 may have a female portion 256 (FIG. 1) of latch 250 mounted to door 330. Also, window 290 may have a different shape between washing machine appliance 100 and dryer appliance 300.

Handle 200 may be provided on both doors 130, 340 in order to provide a uniform appearance between washing machine appliance 100 and dryer appliance 300. For example, door 130 of washing machine appliance 100 can match door 340 of dryer appliance 300 and maintain a uniform appearance because of their substantially identical construction despite door 130 of washing machine appliance 100 opening in a first direction and door 340 of dryer appliance 300 opening in a second opposite direction. Thus, for example, washing machine appliance 100 and dryer appliance 300 may be sold as a washer-dryer pair with a uniform appearance and handle 200.

FIGS. 5-8 illustrate inset 240 being mounted to cover 220 of door 130. In FIG. 5, insert 240 is shown disposed outside of recess 202. As may be seen in FIG. 5, insert 240 includes a lip 244. Lip 244 projects away from insert 240 along the axial direction A and circumferential direction C such that lip 244 is substantially perpendicular to interior surface 241 (shown in FIG. 4) of insert 240. Lip 244 extends projects away from insert 240 between top 204 and bottom 206 of handle 200. As described in greater detail below, lip 262 assists in securing insert 240 within recess 202.

A plurality of tabs 246 projects from insert 260 along axial direction A. Like lip 244, plurality of tabs 246 is substantially perpendicular to an interior surface 241 (shown in FIG. 4) of insert 240. Tabs 264 are distributed on insert 240 from top 204 to bottom 206 of handle 200 along circumferential direction C. Each of the tabs 246 is spaced apart from lip 244 along radial direction R such that a portion of sidewall 230 may be disposed between tabs 246 and lip 244 in order to assist in mounting insert 240 to cover 220 as discussed below.

As may be seen in FIG. 5, projections 248 are also defined by insert 240. Projections 248 extend away from insert 240 along radial direction R such that projections 248 are substantially perpendicular to lip 244. Projections 248 are configured for receipt by slots 208 defined by cover 220. However, slots 208 can also be defined by frame 210 or any other part of door 130. Projections 248 are configured for receipt by slots 208 to assist in mounting insert 240 within recess 202 as discussed in greater detail below.

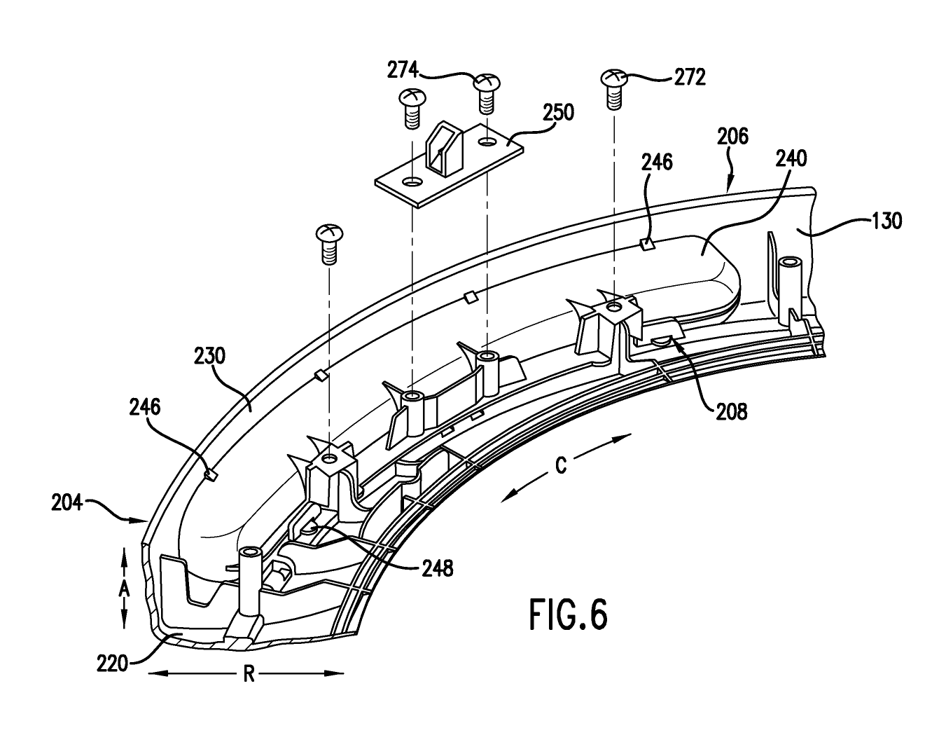

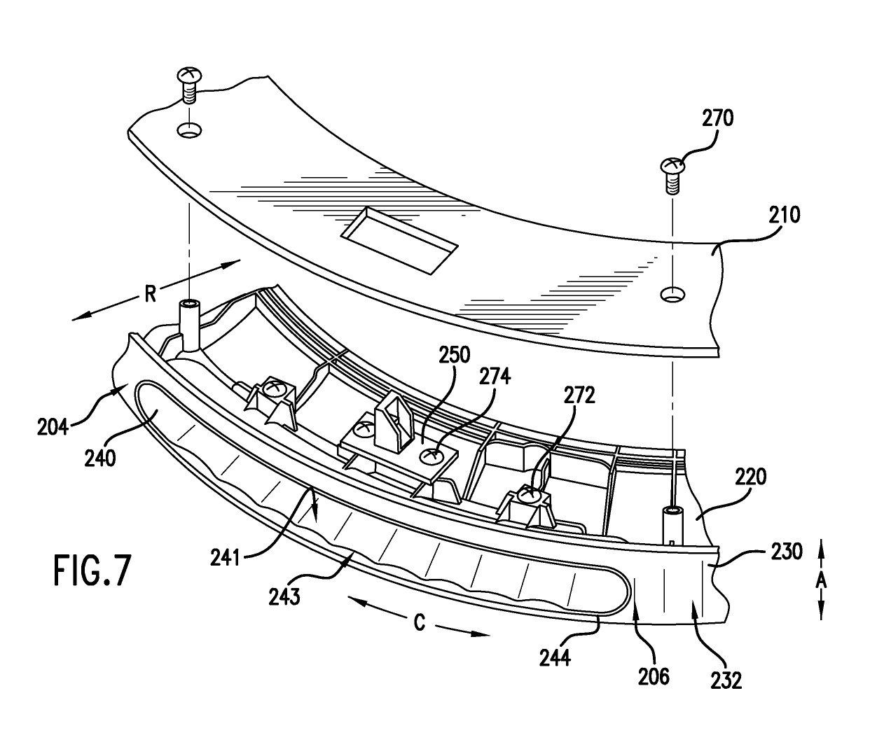

In FIG. 6, insert 240 is disposed in recess 202 (shown in FIG. 5). As may be seen in FIG. 7, when insert 240 is placed in recess 202, lip 244 is positioned adjacent sidewall 230 such that lip 244 is disposed substantially flush with exterior surface 232. Alternatively, lip 244 can also be mounted over exterior surface 232. Turning back to FIG. 6, when insert 240 is disposed within door 130, tabs 246 are also disposed adjacent sidewall 230. Thus, sidewall 230 is disposed between tabs 246 and lip 244 (shown in FIG. 7). During insertion of insert 240 into recess 202, tabs 246 deform sidewalls 230. For example, tabs 246 are angled such that when insert 240 is pressed into recess 202 along radial direction R, sidewall 230 slides up tabs 246 until sidewall 230 snaps into place between tabs 246 and lip 244. By disposing a portion of door 130 between lip 244 and tabs 246, insert 240 can be securely mounted within recess 202 (shown in FIG. 6).

In addition, when insert 240 is placed in recess 202, projections 248 are received by slots 208. When projections 248 are received by slots 208, projections 248 assist in mounting insert 240 within recess 202. For example, when the user pulls on insert 240 along axial direction A, projections 248 assist in transferring the force to door 130 and preventing insert 240 from moving within recess 202. Projections 248 also assist in aligning insert 240 during installation within recess 202.

Insert fasteners 272 are configured for assisting in selectively mounting insert 240 within recess 202. Insert fasteners 272 may extend through insert 240 into cover 220 along axial direction A in order to secure insert 240 to cover 220. It should be understood that, insert fasteners 272 are not required to secure insert 240 to cover 220. Alternative mechanisms may also be used to secure insert 240 to cover 220, e.g., frame fasteners 270.

In FIG. 6 a latch 250 is shown ready for mounting to insert 240 with latch fasteners 274. In FIG. 6, latch 250 is a male latch portion 254 (FIG. 1) with a corresponding female latch portion 256 (FIG. 1) mounted to cabinet 102 of washing machine appliance 100 (FIG. 1). However, in alternative embodiments, latch 250 may be a female latch portion with a corresponding male latch portion mounted to cabinet 102. As described in greater detail below, latch 250 is configured for selectively maintaining door 130 in the closed configuration.

Latch fasteners 274 are configured for selectively securing latch 250 to insert 240. However, in alternative embodiments, latch 250 may be mounted to any other suitable component, e.g., door 130, cover 220, and/or frame 210. Latch fasteners 274 may extend through latch 250 into insert 240 in order to secure latch 250 to inert 240. Alternative mechanisms may also be used to secure latch 250 to insert 240, e.g., clips or glue. By securing latch 250 to insert 240, when a user opens door 130 by pulling on insert 240, force applied by the user to open door 130 is transferred directly to latch 250 from insert 240 via latch fasteners 274 rather than through other components of door 130.

In FIG. 7, cover 220 is shown ready to be mounted to frame 210. To mount cover 220 to frame 210, a plurality of frame fasteners 270 are selectively extended through cover 220 into frame 210. Alternative mechanisms may also be used to secure cover 220 to frame 210. As may be seen in FIG. 7, latch 250 can extend through frame 210 from insert 240.

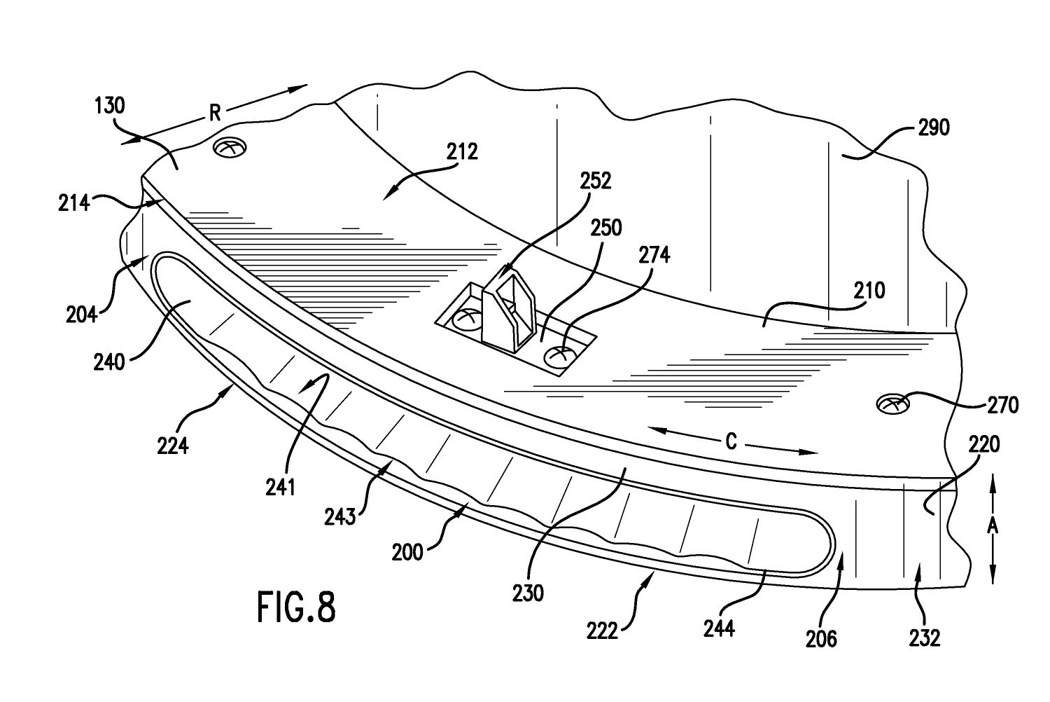

In FIG. 8, cover 220 is shown mounted to frame 210 with fasteners 270. When cover 220 is secured to frame 210 with frame fasteners 270, window 290 is held in place between cover 220 and frame 210. Also shown in FIG. 8, latch 250 extends from door 130. Latch 250 has a tip 252 that is disposed away from door 130. Tip 252 is configured for receipt by female portion 256 of front panel 104 (shown in FIG. 1). When tip 252 is received by cabinet 102, door 130 can be selectively secured in the closed configuration. However, as discussed above, latch 250 may be a female latch portion and, thus, be configured for receipt of tip 252 that extends from front panel 104 of cabinet 102

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance comprising:
a cabinet defining an opening;
a drum rotatably mounted within said cabinet such that said drum rotates about a substantially horizontal axis, said drum defining a chamber configured for receipt of articles, the chamber of said drum being accessible through the opening of said cabinet;
a hinge mounted to said cabinet adjacent the opening of said cabinet;
a door rotatably mounted to said cabinet with said hinge, said door configured for permitting selective access to the chamber of said drum, said door comprising:
an inner surface, a portion of said inner surface being positioned adjacent a front surface of said cabinet, said inner surface having an outer perimeter;
an outer surface spaced apart from said inner surface, said outer surface having an outer edge;
a sidewall that spans between the outer perimeter and the outer edge; and
a handle defined by a recess in said sidewall.

2. The appliance of claim 1, wherein said handle extends longitudinally between a top and a bottom, the top and bottom of said handle being positioned adjacent said sidewall, the top of said handle spaced apart from a horizontal axis by a predetermined distance, the bottom of said handle also spaced apart from the horizontal axis by about the same predetermined distance.

3. The appliance of claim 1, wherein said door has a substantially round profile.

4. The appliance of claim 1, further comprising an insert received within said recess.

5. The appliance of claim 4, further comprising a latch configured for selectively securing said door in a closed configuration, said latch being mounted to said insert.

6. The appliance of claim 5, wherein said latch is mounted to said insert with a fastener, said fastener extending through said latch into said insert.

7. The appliance of claim 1, wherein said appliance is a washing machine appliance.

8. The appliance of claim 1, wherein said appliance is a dryer appliance.

9. An appliance comprising:
a cabinet defining an opening;
a drum rotatably mounted within said cabinet such that said drum rotates about a substantially horizontal axis, said drum defining a chamber configured for receipt of articles, the chamber of said drum being accessible through the opening of said cabinet;
a hinge mounted to said cabinet proximate the opening of said cabinet;
a door rotatably mounted to said cabinet with said hinge, said door configured for permitting selective access to the chamber of said drum, said door comprising:
a frame positioned proximate said cabinet said frame having an outer edge;
a cover complementary in shape to said frame, said cover being aligned with and positioned proximate to said frame, said cover having a frontal surface, the frontal surface of said cover having an outer perimeter;
a sidewall that extends between the outer perimeter of the frontal surface of said cover and the outer edge of said frame; and
a handle defined by a recess within said sidewall.

10. The appliance of claim 9, wherein said handle extends longitudinally between a top and a bottom, the top and bottom of said handle positioned proximate said sidewall, the top of said handle spaced apart from a horizontal axis by a predetermined distance, the bottom of said handle also spaced apart from the horizontal axis by about the same predetermined distance.

11. The appliance of claim 9, wherein said door has a substantially round profile.

12. The appliance of claim 9, further comprising an insert received within said handle.

13. The appliance of claim 12, further comprising a latch configured for selectively securing said door in a closed configuration, said latch being mounted to said insert.

14. The appliance of claim 13, wherein said latch is mounted to said insert with a fastener, said fastener extending through said latch into said insert.

15. The appliance of claim 12, wherein said insert includes a lip and a plurality of tabs, said lip and said plurality of tabs extending away from said insert such that said sidewall is disposed between said plurality of tabs and said lip in order to assist in selectively securing said insert within said handle.

16. The appliance of claim 15, wherein said insert further includes a projection that extends away from said insert, said projection configured for receipt within a slot defined by said frame or said cover in order to assist in selectively securing said insert within said handle.

17. The appliance of claim 12, wherein an additional fastener extends through said frame, said cover, and said insert in order to assist in selectively securing said insert within said handle.

18. The appliance of claim 9, wherein said appliance is a washing machine appliance.

19. The appliance of claim 9, wherein said appliance is a dryer appliance.
